(19) United States
(12) Patent Application Publication
(10) Pub. No.: US 2014/0208918 A1
(43) Pub. Date: Jul. 31, 2014

(54) TEAR LINE FORMING MECHANISM FOR POP-UP TISSUE PAPER PACKAGE FILM

(71) Applicant: CHAN LI MACHINERY CO., LTD., TAOYUAN (TW)

(72) Inventor: WEI-HSIN HSU, TAOYUAN (TW)

(73) Assignee: CHAN LI MACHINERY CO., LTD., TAOYUAN (TW)

(21) Appl. No.: 13/866,248

(22) Filed: Apr. 19, 2013

(30) Foreign Application Priority Data
Jan. 31, 2013 (TW) 102103704

(51) Int. Cl. B26D 3/08

(52) U.S. Cl. CPC B26D 3/085
USPC 83/886

(57) ABSTRACT

A tear line forming mechanism for pop-up tissue paper package film includes a carrier rack, a driving device, a rail mechanism, a shifting mechanism, a pair of couplers, and a rotary cutter holder. The rotary cutter holder is rotatably coupled to the couplers through bearing elements of the couplers and set between the couplers. At least one cutter slot is formed in the rotary cutter holder to receive and hold therein a cutter. A cutter holder gear is coupled to an end of the rotary cutter holder and mates a rack. When the rotary cutter holder is moved in unison with the couplers, the cutter holder gear is caused by being in mating engagement with the rack to rotate in order to proceed with forming tear lines that delimit a package film opening in a pop-up tissue paper package film positioned on an anvil.

### BACKGROUND OF THE INVENTION

1. Field of the Invention

The present invention relates to a design of package film tear line forming mechanisms, and in particular to a tear line forming mechanism for pop-up tissue paper package film that is applied to forming a tear line in a package film of tissue paper.

2. The Related Arts

Heretofore, tissue paper, such as toilet tissues and facial tissues, is manufactured and cut to individual sheets of a desired size. These sheets are then put together with a desired quantity to form a stack. A conventional package of toilet tissue is generally formed by stacking individual sheets together with no additional overlapping made between two adjacent sheets. When the tissues are stacked with a predetermined number of sheets, the stack of tissues formed by the stacking operation is then enclosed with a package film. An opening is formed in the package film to allow a user to easily access the tissues.

However, the conventional way of stacking tissues often causes troubles for users to access and withdraw a single sheet of tissue and consequently, the users cannot control the number of sheets that are withdrawn. This is inconvenient for use and also causes a waste of the tissues.

To improve the problem of inconvenient use of the conventional stacking of tissue, pop-up tissue packages are available in the market, in which the sheets of tissue are stacked in an alternately lapped manner so that pulling out one sheet will cause the next sheet to be partially withdrawn and exposed outside the opening of the package film for easy access and withdrawn by the users in the next use. This improves the convenience of use of tissues and reduces the waste of tissues.

In the conventional package of tissues, the opening in the package film is formed with a line of intermittent perforations. When a user stretches the opposite sides of the perforation line of the package film, undue application of force often results in irregularity of the opening and excessively wide opening so as to deteriorate the appearance of the package film. The tissues enclosed in the package film may thus get undesirably exposed and contaminated and damped.

### SUMMARY OF THE INVENTION

Thus, in view of the problem of irregular opening of the conventional tissue package film caused by undue application of force, the primary object of the present invention is to provide a tear line forming mechanism for pop-up tissue paper, which, during a user breaking the tear line of a pop-up tissue paper package film, helps prevent damaging other portions of the pop-up tissue paper package film.

The technical solution that the present invention adopts to address the above problems of the prior art is that a driving device is employed to drive a shifting mechanism so as to cause the shifting mechanism to move along a rail mechanism in a shifting direction between a first extreme position and a second extreme position. The driving device can be for example a servomotor, a pneumatic cylinder, or a hydraulic cylinder.

A pair of couplers is coupled to the shifting mechanism to be movable in unison with the shifting mechanism in the shifting direction between the first extreme position and the second extreme position. A rotary cutter holder is rotatably coupled to the couplers through bearing elements of the couplers and is set between the couplers.

At least one cutter slot is formed in the rotary cutter holder to receive and hold a cutter. A cutter holder gear is coupled to an end of the rotary cutter holder and mates a rack. When the rotary cutter holder is moved with the couplers, the cutter holder gear is caused by being in mating engagement with the rack to rotate in order to form tear lines that delimit a package film opening in the pop-up tissue paper package film positioned on an anvil. In a practical application, the tear lines collectively form a closed geometric shape, which can be any desired geometric shape, such as a rectangle, a rhomboid, an ellipse, or any other polygonal shapes.

Further, the tear line forming mechanism for pop-up tissue paper package film according to the present invention may further comprise an adjustment mechanism. The adjustment mechanism is coupled to the couplers. A user may operate the adjustment mechanism to move the rotary cutter holder in a horizontal direction to adjust the location of the rotary cutter holder to form the tear lines of the pop-up tissue paper package film.

The tear line forming mechanism for pop-up tissue paper package film according to the present invention further comprises a first extreme position sensor and a second extreme position sensor. The first extreme position sensor and the second extreme position sensor function to detect if the shifting mechanism is moving within the range between the first extreme position and the second extreme position to prevent the shifting mechanism from moving beyond the first extreme position or the second extreme position.

With the technical solution according to the present invention, tear lines that delimit an package film opening can be formed in a pop-up tissue paper package film, whereby damages to the other portions of the pop-up tissue paper package film can be prevented when a user breaks the tear lines and thus fibrous products contained in the pop-up tissue paper package film are protected from being contaminated or damped or the pop-up tissue paper package film being incapable of completely enclosing the fibrous products is prevented.

### BRIEF DESCRIPTION OF THE DRAWINGS

The present invention will be apparent to those skilled in the art by reading the following description of preferred embodiments of the present invention, with reference to the attached drawings, in which:

FIG. 1 is a schematic view showing a tear line forming mechanism for pop-up tissue paper package film according to the present invention;

FIG. 2 is a schematic top plan view showing the tear line forming mechanism for pop-up tissue paper package film according to the present invention;

FIG. 3 is a schematic right side elevational view showing the tear line forming mechanism for pop-up tissue paper package film according to the present invention;

FIG. 4 is a schematic left side elevational view showing the tear line forming mechanism for pop-up tissue paper package film according to the present invention;

FIG. 5 is a schematic top plan view showing a rotary cutter holder according to the present invention;

FIG. 6 is a schematic enlarged view of a portion of FIG. 5;

FIG. 7 is a schematic view showing the rotary cutter holder and an anvil;

FIG. 8 is a schematic view showing a package film opening and tear lines formed in a pop-up tissue paper package film according to the present invention;

FIG. 9 is a schematic view showing the package film opening of the pop-up tissue paper package film according to the present invention;

FIG. 10 is a schematic view showing a first example of the tear lines of the pop-up tissue paper package film according to the present invention;

FIG. 11 is a schematic view showing a second example of the tear lines of the pop-up tissue paper package film according to the present invention; and

FIG. 12 is a schematic view showing a third example of the tear lines of the pop-up tissue paper package film according to the present invention.

### DETAILED DESCRIPTION OF THE PREFERRED EMBODIMENTS

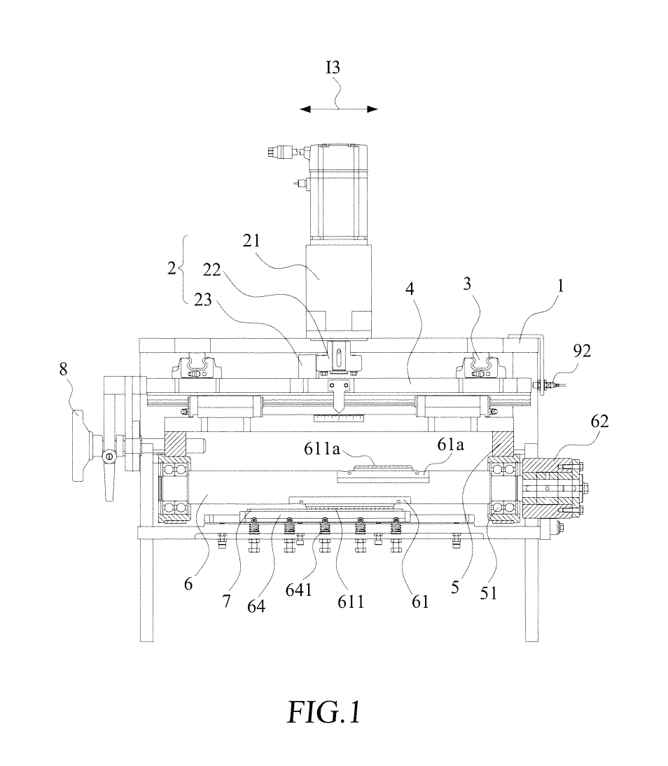

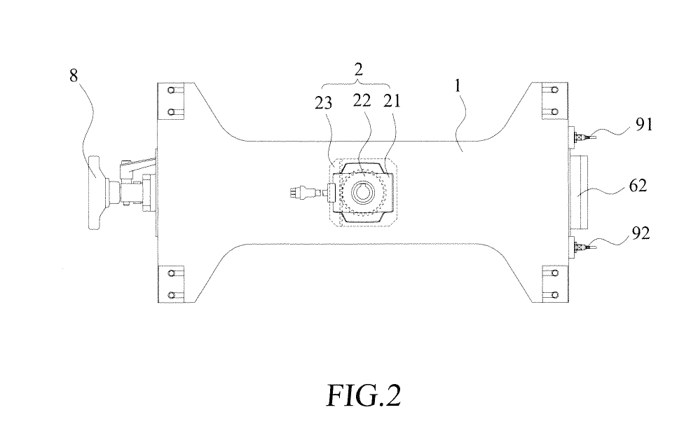

With reference to the drawings and in particular to FIGS. 1 and 2, FIG. 1 is a schematic view showing a tear line forming mechanism for pop-up tissue paper package film according to the present invention and FIG. 2 is a schematic top plan view showing the tear line forming mechanism for pop-up tissue paper package film according to the present invention. As shown in the drawings, the tear line forming mechanism for pop-up tissue paper package film according to the present invention comprises a carrier rack 1, a driving device 2, a rail mechanism 3, a shifting mechanism 4, a pair of couplers 5, and a rotary cutter holder 6. The rail mechanism 3 is mounted on the carrier rack 1 to extend in a shifting direction I1.

The driving device 2 is mounted to the carrier rack 1. The driving device 2 comprises a driving motor 21, a driving gear 22, and a driving rack 23. The driving gear 22 is coupled to the driving motor 21 and is driven by the driving motor 21 to rotate. The driving rack 23 is mounted to the shifting mechanism 4 to extend in a shifting direction I1 and mate the driving gear 22. The driving device 2 can be any one of a servomotor, a pneumatic cylinder, and a hydraulic cylinder.

The shifting mechanism 4 is coupled to the driving device 2 to be driven by the driving device 2 to move in the shifting direction I1 along the rail mechanism 3 between a first extreme position P1 and a second extreme position P2. The couplers 5 are coupled to the shifting mechanism 4 to be movable in unison with the shifting mechanism 4 for moving in the shifting direction I1 between the first extreme position P1 and the second extreme position P2. The couplers 5 each comprise a bearing element 51.

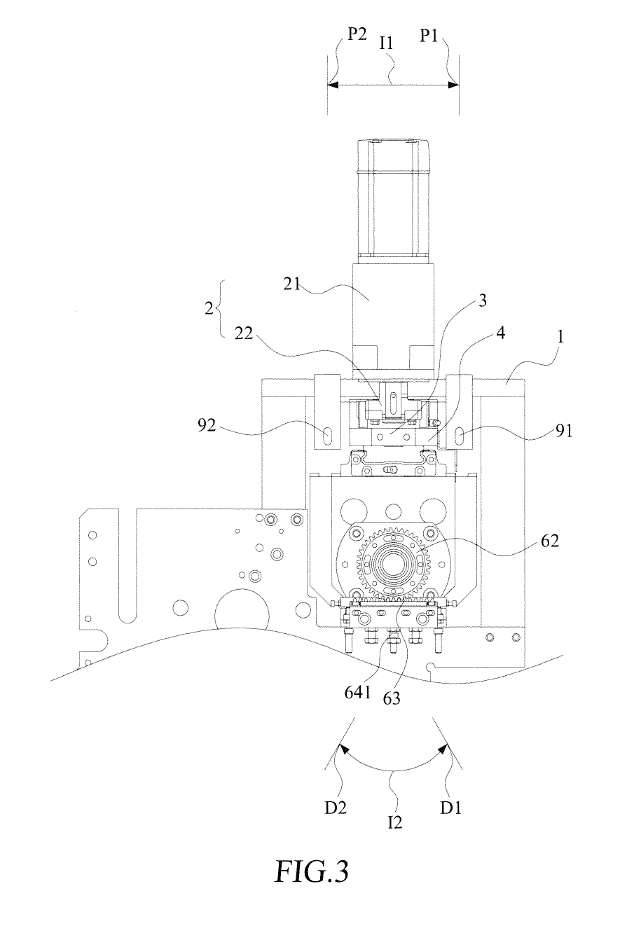

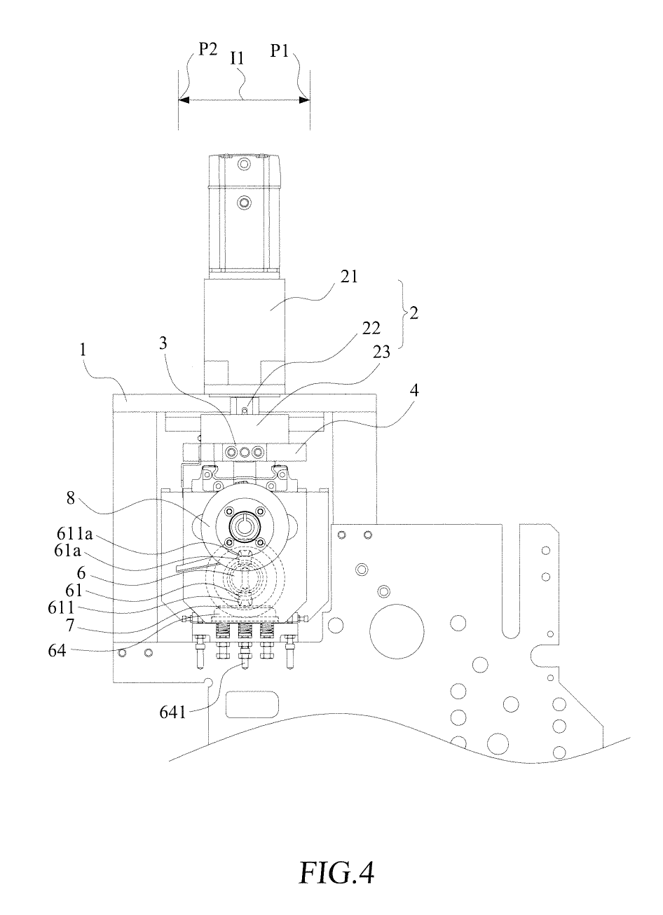

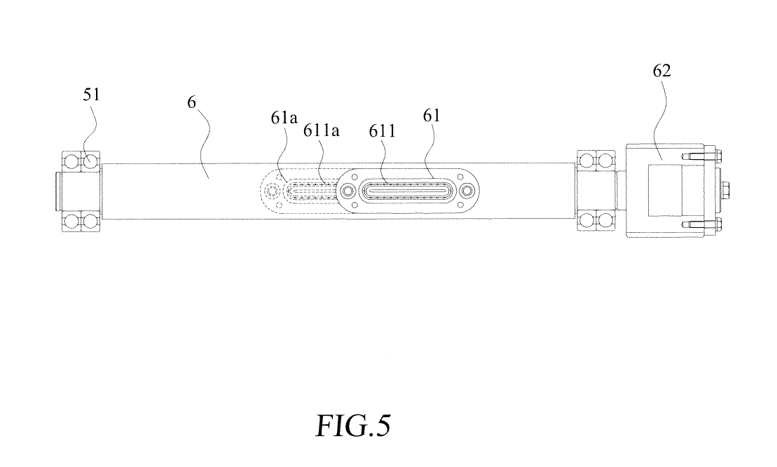

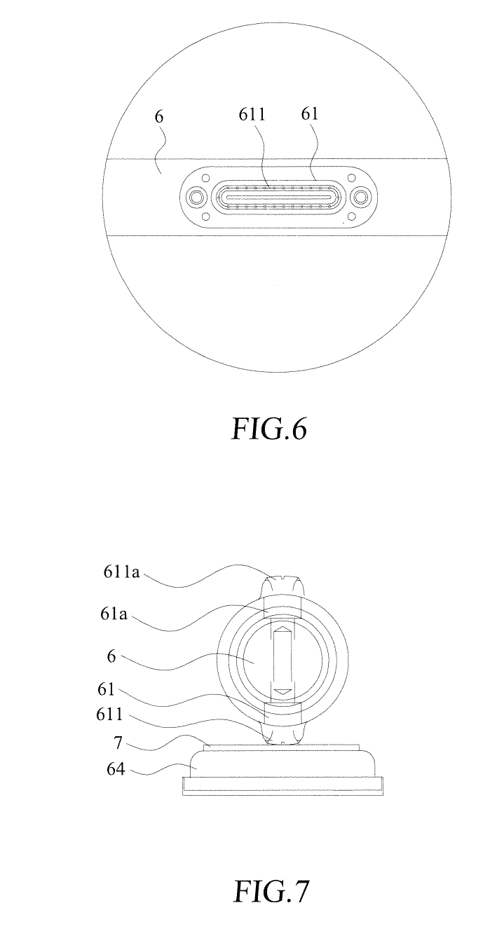

Also referring to FIGS. 3-6, FIG. 3 is a schematic right side elevational view showing the tear line forming mechanism for pop-up tissue paper package film according to the present invention; FIG. 4 is a schematic left side elevational view showing the tear line forming mechanism for pop-up tissue paper package film according to the present invention; FIG. 5 is a schematic top plan view showing a rotary cutter holder according to the present invention; and FIG. 6 is a schematic enlarged view of a portion of FIG. 5. As shown in the drawings, the rotary cutter holder 6 is rotatably coupled to the couplers 5 through the bearing elements 51 of the couplers 5 and is set between the couplers 5. The rotary cutter holder 6 is movable in unison with the couplers 5 in the shifting direction I1 between the first extreme position P1 and the second extreme position P2.

As shown in FIGS. 1 and 5, a first cutter slot 61 is formed in a predetermined location in the rotary cutter holder 6 for receiving and holding a first perforation cutter 611. A cutter holder gear 62 is coupled to an end of the rotary cutter holder 6 and mates a rack 63. The rack 63 is mounted on the carrier rack 1 to extend in the shifting direction I1 and mates the cutter holder gear 62. The first cutter slot 61 and the first perforation cutter 611 can be adjusted in sizes thereof according to practical needs and are not limited to any specific sizes.

Further, the rotary cutter holder 6 is provided with a second cutter slot 61a that is formed in a predetermined location at an opposite side for receiving and holding a second perforation cutter 611a (as shown in FIGS. 1 and 5). The second cutter slot 61a and the second perforation cutter 611a can be adjusted in sizes thereof according to practical needs and are not limited to any specific sizes.

Further referring to FIGS. 1 and 7, FIG. 7 is a schematic view showing the rotary cutter holder and an anvil. As shown in the drawings, an anvil 64 is mounted to the carrier rack 1 and located below the rotary cutter holder 6. The anvil 64 carries and supports at least one pop-up tissue paper package film 7 positioned thereon. The pop-up tissue paper package film 7 comprises a package film opening 71 formed therein.

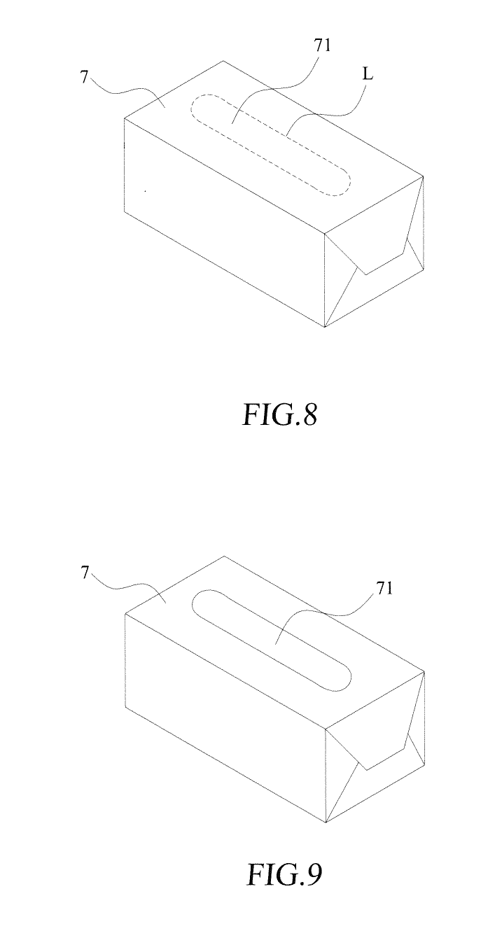

Referring to FIGS. 8 and 9, FIG. 8 is a schematic view showing a package film opening and tear lines formed in a pop-up tissue paper package film according to the present invention and FIG. 9 is a schematic view showing the package film opening of the pop-up tissue paper package film according to the present invention. As shown in the drawings, the pop-up tissue paper package film 7 comprises a package film opening 71 formed therein. The tear line forming mechanism for pop-up tissue paper package film according to the present invention is applicable to forming tear lines L that delimits the package film opening 71 of the pop-up tissue paper package film 7.

When the rotary cutter holder 6 is movable with the couplers 5 in the shifting direction I1 between the first extreme position P1 and the second extreme position P2, the cutter holder gear 62, due to being in mating engagement with the rack 63, is caused to rotate in a rotation direction I2 between a first rotation dead point D1 and a second rotation dead point D2 in order to form the tear lines L of the package film opening 71 in the pop-up tissue paper package film 7 that is positioned on the anvil 64.

When the pop-up tissue paper package film 7 is so processed to form the tear lines L of the package film opening 71, in an attempt to withdraw and use tissue paper, a user can easily breaks the tear lines L of the pop-up tissue paper package film 7 to access and withdraw a sheet of fibrous product contained in the pop-up tissue paper package film 7 through the package film opening 71. The term “fibrous product” used here can refer to for example toilet tissues, facial tissues, table napkins, or wet towels.

The tear line forming mechanism for pop-up tissue paper package film according to the present invention is applicable to forming tear lines L in a pop-up tissue paper package film 7 for defining a package film opening 71. In the instant embodiment, the tear lines L collectively form a closed geometrical shape so that damages to the other portions of the pop-up tissue paper package film 7 are prevented when a user breaks the tear lines L and thus the fibrous products contained in the pop-up tissue paper package film 7 are protected from being contaminated or damped or the pop-up tissue paper package film 7 being incapable of completely enclosing the fibrous products is prevented.

Further, the anvil 64 is provided, preferably at an underside thereof, with at least one anvil height adjustment element 641. The anvil height adjustment element 641 functions to adjust the distance between the anvil 64 and the first perforation cutter 611 in order to ensure desired engagement of the first perforation cutter 611 of the rotary cutter holder 6 with the pop-up tissue paper package film 7 to form the tear lines L of the package film opening 71 in the pop-up tissue paper package film 7.

The tear line forming mechanism for pop-up tissue paper package film according to the present invention may further comprise an adjustment mechanism 8. The adjustment mechanism 8 is coupled to the couplers 5. A user may operate the adjustment mechanism 8 to move the rotary cutter holder 6 in a horizontal direction I3 to adjust the location of the rotary cutter holder 6 to form the tear lines L of the pop-up tissue paper package film 7.

Further, the tear line forming mechanism for pop-up tissue paper package film according to the present invention further comprises a first extreme position sensor 91 and a second extreme position sensor 92. The first extreme position sensor 91 and the second extreme position sensor 92 function to detect if the shifting mechanism 4 is moving within the range between the first extreme position P1 and the second extreme position P2 to prevent the shifting mechanism 4 from moving beyond the first extreme position P1 or the second extreme position P2.

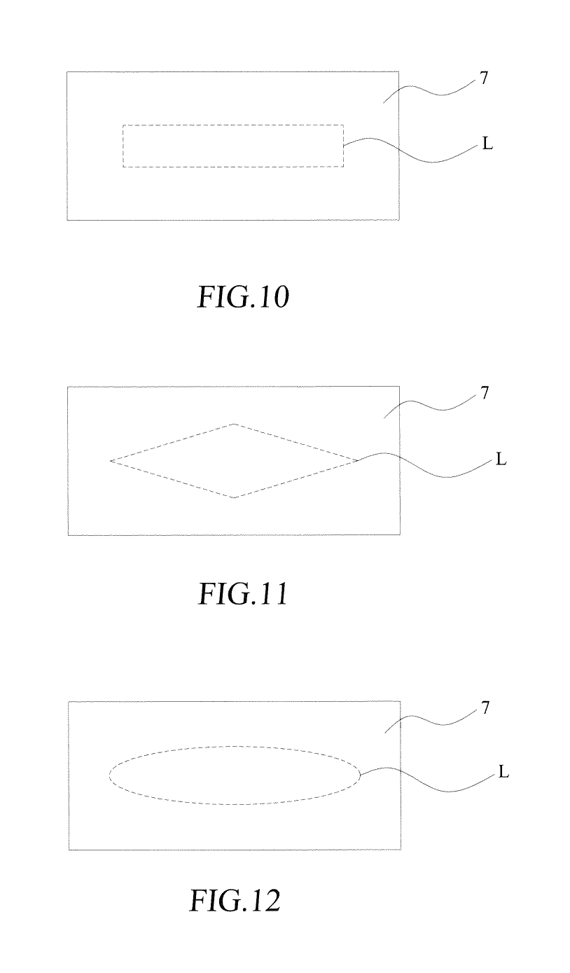

Referring to FIGS. 10-12, FIG. 10 is a schematic view showing a first example of the tear lines of the pop-up tissue paper package film according to the present invention; FIG. 11 is a schematic view showing a second example of the tear lines of the pop-up tissue paper package film according to the present invention; and FIG. 12 is a schematic view showing a third example of the tear lines of the pop-up tissue paper package film according to the present invention. As shown in the drawings, the tear lines L collectively form a closed geometric shape, which can be any desired geometric shape, such as a rectangle, a rhomboid, an ellipse, or any other polygonal shapes.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A tear line forming mechanism for pop-up tissue paper package film, comprising:
a carrier rack;
a shifting mechanism, which is mounted to the carrier rack and is movable in a shifting direction between a first extreme position and a second extreme position;
a pair of couplers, which are mounted to the shifting mechanism to be movable in unison with the shifting mechanism in the shifting direction between the first extreme position and the second extreme position, the couplers comprising therein bearing elements;
a rotary cutter holder, which is rotatably coupled to the pair of couplers through the bearing elements of the pair of couplers and is set between the pair of couplers, the rotary cutter holder being movable in unison with the couplers in the shifting direction between the first extreme position and the second extreme position;
at least one cutter slot, which is formed in a predetermined location in the rotary cutter holder to receive and hold at least one cutter;
a cutter holder gear, which is coupled to one end of the rotary cutter holder;
a rack, which is mounted on the carrier rack to extend in the shifting direction and mate the cutter holder gear; and
an anvil, which is mounted to the carrier rack and located below the rotary cutter holder, the anvil being adapted to carry and support at least one pop-up tissue paper package film for forming a package film opening in the pop-up tissue paper package film;
wherein when the rotary cutter holder is movable with the couplers in the shifting direction between the first extreme position and the second extreme position, the cutter holder gear is caused by being in mating engagement with the rack to rotate in a rotation direction between a first rotation dead point and a second rotation dead point in order to form tear lines that delimit the package film opening in the pop-up tissue paper package film supported on the anvil.

2. The tear line forming mechanism for pop-up tissue paper package film as claimed in claim 1, wherein the anvil is provided, on an underside thereof, with at least one anvil height adjustment element, which selectively adjusts a distance between the anvil and the cutter.

3. The tear line forming mechanism for pop-up tissue paper package film as claimed in claim 1 further comprising an adjustment mechanism, which is coupled to the couplers, whereby the adjustment mechanism is operable to drive the rotary cutter holder to move in a horizontal direction.

4. The tear line forming mechanism for pop-up tissue paper package film as claimed in claim 1, wherein the carrier rack comprises a first extreme position sensor that detects if the shifting mechanism moves to the first extreme position.

5. The tear line forming mechanism for pop-up tissue paper package film as claimed in claim 1, wherein the carrier rack comprises a second extreme position sensor that detects if the shifting mechanism moves to the second extreme position.

6. A tear line forming mechanism for pop-up tissue paper package film, comprising:
a carrier rack;
a driving device, comprising:
a driving motor, which is mounted on the carrier rack,
a driving gear, which is coupled to the driving motor and is driven by the driving motor to rotate, and
a driving rack, which is mounted to the shifting mechanism to extends in a shifting direction and mates the driving gear;
a rail mechanism, which is mounted on the carrier rack to extend in the shifting direction;
a shifting mechanism, which is mounted to the driving rack so that the driving motor drives, via the driving gear and the driving rack, the shifting mechanism to move along the rail mechanism in the shifting direction between a first extreme position and a second extreme position;
a pair of couplers, which are mounted to the shifting mechanism to be movable in unison with the shifting mechanism in the shifting direction between the first extreme position and the second extreme position, the couplers comprising therein bearing elements;
a rotary cutter holder, which is rotatably coupled to the pair of couplers through the bearing elements of the pair of couplers and is set between the pair of couplers, the rotary cutter holder being movable in unison with the couplers in the shifting direction between the first extreme position and the second extreme position;
at least one cutter slot, which is formed in a predetermined location in the rotary cutter holder to receive and hold at least one cutter;
a cutter holder gear, which is coupled to one end of the rotary cutter holder; and
a rack, which is mounted on the carrier rack to extend in the shifting direction and mate the cutter holder gear;
wherein when the rotary cutter holder is movable with the couplers in the shifting direction between the first extreme position and the second extreme position, the cutter holder gear is caused by being in mating engagement with the rack to rotate in a rotation direction between a first rotation dead point and a second rotation dead point.

7. The tear line forming mechanism for pop-up tissue paper package film as claimed in claim 6 further comprising an adjustment mechanism, which is coupled to the couplers, whereby the adjustment mechanism is operable to drive the rotary cutter holder to move in a horizontal direction.

8. The tear line forming mechanism for pop-up tissue paper package film as claimed in claim 6, wherein the carrier rack comprises a first extreme position sensor that detects if the shifting mechanism moves to the first extreme position.

9. The tear line forming mechanism for pop-up tissue paper package film as claimed in claim 6, wherein the carrier rack comprises a second extreme position sensor that detects if the shifting mechanism moves to the second extreme position.
